(19) United States
(12) Patent Application Publication
(10) Pub. No.: US 2003/0076429 A1
(43) Pub. Date: Apr. 24, 2003

(54) Image capturing apparatus

(75) Inventors: Toshihiko Karasaki, Kawachinagano-Shi (JP); Noriyuki Okisu, Osakasayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/272,212

(22) Filed: Oct. 16, 2002

(30) Foreign Application Priority Data
Oct. 18, 2001 (JP) P2001-320491

(51) Int. Cl. H04N 5/222

(52) U.S. Cl. 348/240.2; 348/333.12

(57) ABSTRACT

An object of the present invention is to provide an image capturing apparatus having a function capable of setting a focus position in a subject not only in the center of a screen, thereby improving its operability on checking of a focus state in a checking mode. At the time of reviewing a captured image, the whole captured image is not displayed on a display but, to make the user easily check a focus state, a part of the captured image is enlarged and the enlarged image is displayed in the full screen on the display. In this case, according to an image capturing pixel mode, magnification M of an image is automatically changed. For example, in a very high resolution mode of 1600×1200, the magnification M is 8. In a high resolution mode of 800×600, the magnification M is 4. In a standard mode of 640×480, the magnification M is 3.2.

This application is based on application No. 2001-320491 filed in Japan, the contents of which are hereby incorporated by reference.

### BACKGROUND OF THE INVENTION

1. Field of the Invention

The present invention relates to an image capturing apparatus having a function capable of setting a focus position in a subject not only in the center of a screen.

2. Description of the Background Art

Japanese Patent Application Laid-Open No. 11-196301 (1999) discloses a digital camera having a function of enlarging an image in a focus frame in an image which is not captured or has captured and displaying the enlarged image. The publication describes that the focus frame is not fixed in the center of a screen but can be moved to an arbitrary position designated by a key operation of the user.

According to the background art, however, since the focus frame has a predetermined size (area), by designation of a focus position by moving the focus frame in the screen, an end part of the screen cannot be designated as the intention of the user. Such a inconvenience can be solved by designating a position by using a cross cursor, not focus frame (that is, by point designation, not area designation) as in a first embodiment of the present invention which will be described later. In this case, however, it is necessary to examine what to do when the cross cursor is moved to an end of the screen (a third embodiment to be described later).

In conventional digital cameras, the number of pixels is increasing and, on the other hand, the number of pixels used for capturing an image is changeable according to use of the image or the like.

The above-described publication, however, does not disclose the magnification at the time of enlarging and displaying an image captured. Therefore, when an image is captured in a mode where the number of pixels is relatively small, a situation such that the image is excessively enlarged and displayed may occur. In the conventional digital camera disclosed in the publication, a rational magnification is not examined sufficiently, and there is a problem the operability deteriorates by the user like in the case where an image is not enlarged at a proper magnification.

### SUMMARY OF THE INVENTION

The present invention is directed to an image capturing apparatus.

According to the present invention, an image capturing apparatus includes: an image sensor for capturing an image of a subject and generating image data; a display for displaying an image based on the image data generated by the image sensor onto a screen; a designating member for designating a specific position in the subject on the screen; a selector for selecting the number of pixels of an image captured by the image sensor; and a display controller for enlarging an image in a predetermined area including the specific position designated by the designating member and displaying the enlarged image on the display, wherein the display controller changes magnification of the image in the predetermined area in accordance with the number of pixels of the captured image selected by the selector.

Consequently, the image capturing apparatus can automatically change the magnification of the predetermined area in accordance with the number of pixels of the captured image selected by the selector, so that an image enlarged at a proper magnification for each number of pixels of a captured image can be displayed on the screen of the display.

According to one preferred aspect of the present invention, the designating member designates a focus position in the subject.

In the aspect, the image obtained by enlarging the predetermined area including the focus position at a proper magnification can be displayed on the screen of the display.

According to another preferred aspect of the present invention, the image capturing apparatus further includes: an operating member for scrolling the image enlarged and displayed by the display controller.

In the aspect, since the enlarged image can be scrolled, the state of the peripheral area in the area displayed as an enlarged image can be checked. Moreover, since the magnification is optimized, the number of scrolling times can be minimized, and operability of checking an enlarged image is improved.

According to still another preferred aspect of the present invention, the image capturing apparatus further includes: an operating member for changing the magnification of an image enlarged and displayed by the display controller.

In the aspect, the magnification can be changed according to the situation of the subject or preference of the user, so that the operability is further improved.

According to yet another preferred aspect of the present invention, the display controller enlarges an image in the predetermined area including the specific position designated by the designating member and displays the enlarged image on the display at the time of reproducing the captured image.

In the aspect, at the time of reproducing a captured image, an image enlarged at a proper magnification for each number of pixels of a captured image can be displayed on the screen.

According to the present invention, an image capturing apparatus includes: an image sensor for capturing an image of a subject and generating image data; a display for displaying an image based on the image data generated by the image sensor onto a screen; a designating member for designating a specific position in the subject on the screen; and a display controller for enlarging an image in a predetermined area including a specific position designated by the designating member and displaying the enlarged image on the display at the time of reproducing the captured image, wherein the display controller displays the enlarged image so that a part other than the image is not displayed on the display.

With the configuration, an enlarged image can be displayed on the screen without a missing part. It can be therefore prevented that the user feels strange to see an enlarged image with a missing part.

In one preferred aspect of the present invention, the designating member designates a focus position in the subject.

In the aspect, the area including the focus position is enlarged and the enlarged image is displayed on the screen. Consequently, by referring to the enlarged image displayed on the display, whether a desired focus state is obtained or not can be checked by the user.

In another preferred aspect of the present invention, the display controller changes the magnification of the image in the predetermined area in accordance with the specific position designated by the designating member.

In still another preferred aspect of the present invention, the display controller changes the magnification of the image in the predetermined area in a state where a center position of the predetermined area and the specific position designated by the designating member coincide with each other.

According to the aspect, as the relation that the center position of the predetermined area and the specific position coincide with each other is maintained, there is no change in the line of sight of the user before and after image capturing, so that improvements in operability can be achieved.

In yet another preferred aspect of the present invention, when a position in the vicinity of an end of a screen is designated as the specific position by the designating member and a part of the predetermined area lies off the screen, the display controller moves the predetermined area so that the predetermined area lies within the screen.

According to the aspect, the enlarged image can be always displayed so as to be within the screen, and improvements in operability can be achieved.

According to the present invention, an image capturing apparatus includes: an image sensor for capturing an image of a subject and generating image data; a display for displaying an image based on the image data generated by the image sensor onto a screen; a designating member for designating a specific position in the subject on the screen; and a display controller for enlarging an image in a predetermined area including the specific position designated by the designating member and displaying the enlarged image on the display at the time of reproducing the captured image, wherein when a position in the vicinity of an end of the screen is designated as a specific position by the designating member and a part of the predetermined area lies off the screen, the display controller produces a predetermined display other than an image in a portion corresponding to the part of the predetermined area.

With the configuration, it can be clearly shown that an area which cannot be displayed on the screen exists can in the screen.

The present invention has been achieved to solve the conventional problems and its object is therefore to provide an image capturing apparatus having a function of enlarging a part of a captured image and displaying the enlarged image onto a screen, thereby achieving improvements in its operability in enlargement and display.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing the structure of a digital camera according to a first embodiment of the present invention;

FIG. 2 is a rear view showing the structure of the digital camera according to the first embodiment of the present invention;

FIG. 3 is a side view showing the structure of the digital camera according to the first embodiment of the present invention;

FIG. 4 is a bottom view showing the structure of the digital camera according to the first embodiment of the present invention;

FIG. 5 is a block diagram showing the internal configuration of the digital camera according to the first embodiment of the present invention;

FIG. 6 is a block diagram concretely showing a part of the internal configuration of the digital camera according to the first embodiment of the present invention;

FIG. 7 is a conceptual diagram for describing live view display;

FIG. 8 is a block diagram concretely showing a part of the internal configuration of the digital camera according to the first embodiment of the present invention;

FIG. 9 is a schematic diagram for describing metering in a digital camera;

FIG. 10 is a schematic diagram for describing metering in the digital camera;

FIG. 11 is a schematic diagram for describing metering in the digital camera;

FIG. 12 is a flowchart for concretely describing the operation of the digital camera according to the first embodiment of the present invention;

FIG. 13 is a schematic diagram showing an example of a display screen of an LCD;

FIG. 14 is a diagram showing the relation between an image capturing pixel mode and a magnification;

FIG. 15 is a schematic diagram showing an area to be enlarged for each number of pixels of a captured image;

FIG. 16 is a schematic diagram showing an example of a display screen of an LCD;

FIG. 17 is a schematic diagram for describing manual switching of a magnification;

FIG. 18 is a flowchart for concretely describing the operation of a digital camera according to a second embodiment of the present invention;

FIG. 19 is a schematic diagram for describing a method of calculating a magnification;

FIG. 20 is a flowchart for concretely describing the operation of a digital camera according to a third embodiment of the present invention;

FIG. 21 is a schematic diagram showing an example of the display screen of the LCD;

FIG. 22 is a schematic diagram showing an area to be enlarged;

FIG. 23 is a schematic diagram showing a situation where the area to be enlarged is moved;

FIG. 24 is a schematic diagram showing an example of the display screen of the LCD; and

FIG. 25 is a schematic diagram showing an example of the display screen of the LCD.

### DESCRIPTION OF THE PREFERRED EMBODIMENTS

Hereinafter, preferred embodiments of the present invention will be described in detail with reference to the drawings. In the following, an embodiment regarding a digital camera will be described as an example of an image capturing apparatus.

First Embodiment

Configuration of Main Components of Digital Camera

FIGS. 1 to 4 are a front view, a rear view, a side view and a bottom view of a digital camera 1 according to an embodiment of the present invention. FIG. 5 is a block diagram showing the internal configuration of the digital camera 1.

The digital camera 1 is constructed by, as shown in FIG. 1, a box-shaped camera body part 2 and an image capturing part 3 of a rectangular parallelepiped shape (indicated by thick lines in FIGS. 1, 2 and 4). The image capturing part 3 has a zoom lens 301 with a macro function as an imaging lens and, in a manner similar to a lens shutter camera using a silver film (hereinafter, referred to as a “silver-film camera”), a light control sensor 305 for receiving reflected light of flash light from a subject, and an optical finder 31. The zoom lens 301 can zoom in and out on a subject in a range of focal distance from 35 mm to 70 mm in terms of a silver camera using a 35 mm film.

The image capturing part 3 has therein a CCD 303 (see FIG. 5) as a CCD color area sensor functioning as image capturing device in a position rearward of the zoom lens 301, and the CCD 303 is a part of an image capturing circuit 302. The CCD 303 has 1600 pixels horizontally by 1200 pixels vertically.

As shown in FIG. 1, in the front face of the camera body part 2, a grip part 4 is provided at the left end, a built-in flash 5 is provided in the upper part of the center, and a shutter button 8 is provided on the top face.

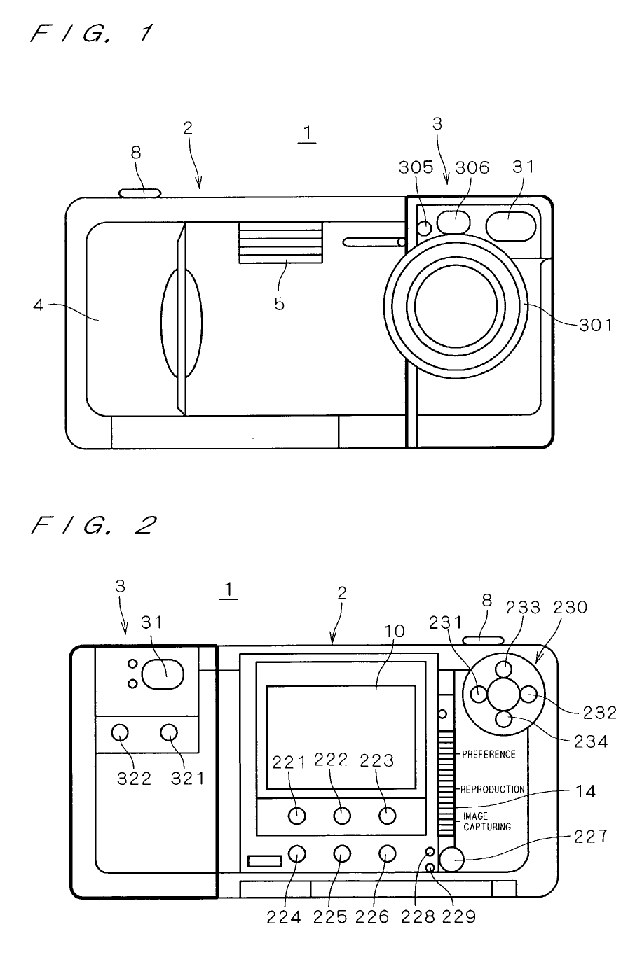

As shown in FIG. 2, in an almost center portion of the rear face of the camera body part 2, an LCD 10 for displaying a captured image (corresponding to a view finder) and reproducing and displaying a recorded image is provided. The LCD 10 has a display screen with 400 pixels horizontally by 300 pixels vertically. Below the LCD 10, a group of key switches 221 to 226 for performing the operation on the digital camera 1 and a power supply switch 227 are provided. The key switch 224 functions as a button for switching a focus mode between a manual focus (MF) mode and an auto focus (AF) mode. The key switch 225 functions as an AF cursor button for displaying an AF cursor CR (focus designation indication) for designating the focus position in a subject on the LCD 10. As will be described later, the key switch (AF cursor button) 225 also functions as a button for changing the magnification of an enlarged image G2 displayed on the LCD 10. The key switch 226 functions as a menu button. On the left side of the power supply switch 227, an LED 228 which is turned on when the power source is turned on, and an LED 229 which is turned on when a memory card is accessed are disposed.

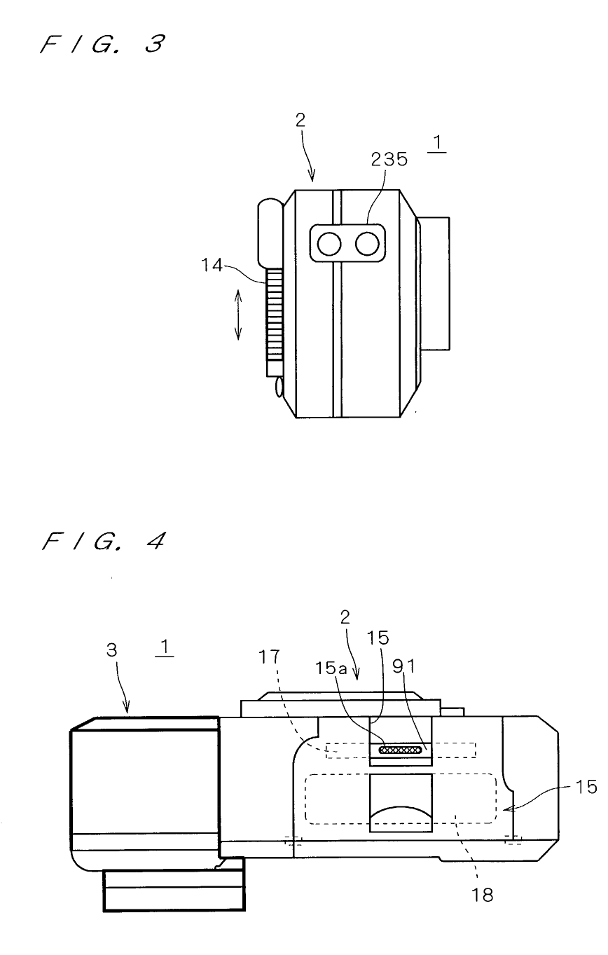

On the rear face of the camera body part 2, a mode setting switch 14 for switching a mode among an “image capturing mode”, a “reproduction mode”, and a “preference mode” is provided (see FIG. 3). The image capturing mode is a mode of taking a picture. The reproduction mode is a mode of reproducing a captured image recorded in a memory card 91 and displaying the image onto the LCD 10. Further, the preference mode is a mode of making various settings by selecting one of display items (setting items) displayed on the LCD 10. The digital camera 1 has a function capable of changing the number of pixels of the CCD 303 used for capturing an image and can be switch to an arbitrary image capturing pixel mode among a very high resolution mode of 1600×1200 (1,920,000) pixels, a high resolution mode of 800×600 (480,000) pixels, and a standard mode of 640×480 (300,000) pixels selected by the user by operating a four-way switch 230. The digital camera 1 also has a review function (also referred to as a “quick view function”) of automatically displaying the latest captured image on the LCD 10 so that the user can determine whether the image is recorded or not after checking a focus state or the like.

The mode setting switch 14 is a slide switch of three contacts. In FIG. 2, when the mode setting switch 14 is set to the down, the image capturing mode is set. When the mode setting switch 14 is set to the center, the reproduction mode is set. When the mode setting switch 14 is set to the up, the preference mode is set.

In the right part of the rear face of the camera, the four-way switch 230 is provided. By depressing buttons 231 and 232 in the image capturing mode, the focal distance of the zoom lens 301 is changed to perform zooming of changing the zoom magnification. By depressing buttons 233 and 234, exposure correction can be manually performed. By depressing the buttons 233 and 234 in the manual focus mode, an AF motor 308 is driven and a focal point can be adjusted manually. In an image capturing standby state in the image capturing mode (which is a state where live view display of moving images is performed on the LCD 10 and is also referred to as a “preview mode”), the AF cursor CR can be moved up, down, right or left by the operation of the four-way switch 230. Further, as will be described later, the four-way switch 230 also functions as a button for scrolling the enlarged image G2 displayed on the LCD 10.

On the rear face of the image capturing part 3, as shown in FIG. 2, an LCD button 321 for turning on/off the LCD 10 and a macro button 322 are provided. When the LCD button 321 is depressed, the on/off state of the LCD display is switched. For example, in the case of capturing an image only by using the optical finder 31, the LCD display is turned off to save power. At the time of macro image capturing, by depressing the macro button 322, an AF motor 308 (see FIG. 5) is driven and the zoom lens 301 can perform macro image capturing.

On a side face of the camera body part 2, a DC input terminal 235 is provided as shown in FIG. 3.

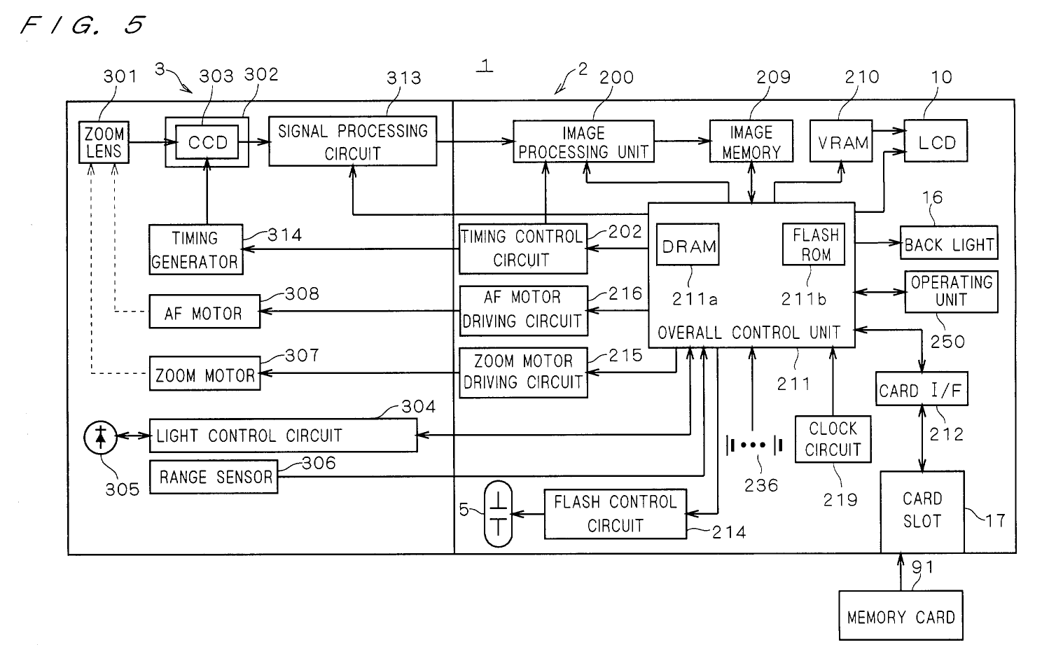

In the bottom face of the camera body part 2, as shown in FIG. 4, a battery loading room 18 and a card loading room 17 (card slot) are provided. The memory card 91 or the like can be loaded in the card loading room 17. The card loading room 17 can be closed by a clamshell-type cover 15. In the cover 15, an opening 15a is formed.

In the digital camera 1, by loading four AA cells to the battery loading room 18, a power supply battery 236 (see FIG. 5) obtained by connecting the four AA cells in series is used as a drive source. Obviously, the power from an adapter can be supplied from the DC input terminal 235 shown in FIG. 3.

The internal configuration of the image capturing part 3 will now be described with reference to FIG. 5.

The image capturing circuit 302 photoelectrically converts an optical image of a subject formed on the CCD 303 by the zoom lens 301 by using the CCD 303, and outputs the resultant as image signals (signals including signal columns of pixel signals received by pixels) of color components of R (red), G (green) and B (blue).

Since the f number can be set in a few stages in the digital camera 1 by a key operation of the user. Exposure control in the image capturing part 3 is performed by adjusting an exposure amount of the CCD 303 (charge accumulation time of the CCD 303 corresponding to a shutter speed). When the luminance of the subject is low and a proper shutter speed cannot be set, improper exposure due to insufficient exposure is corrected by adjusting the level of an image signal outputted from the CCD 303. In other words, at the time of low luminance, exposure control is performed by combining the shutter speed and gain adjustment. The level of an image signal is adjusted by an AGC (Auto Gain Control) circuit in a signal processing circuit 313 which will be described later. Metering in the automatic exposure (AE) will be described in detail later.

A timing generator 314 generates a drive control signal of the CCD 303 synchronously with a clock transmitted from the timing control circuit 202 in the camera body part 2. The timing generator 314 generates, for example, timing signals of start and end of integration (that is, start and end of exposure) and clock signals such as read control signals (a horizontal sync signal, a vertical sync signal, a transfer signal and the like) of photosensitive signals of pixels and outputs the signals to the CCD 303.

A signal processing circuit 313 performs a predetermined analog signal process on an image signal (analog signal) outputted from the image capturing circuit 302. The signal processing circuit 313 has therein, although not shown, a CDS (Correlated Double Sampling) circuit and an AGC circuit. Noise of an image signal is reduced by the CDS circuit and the gain of the AGC circuit is adjusted, thereby adjusting the level of an image signal.

The light control circuit 304 controls the light emission amount of the built-in flash 5 in image capturing with a flash to a predetermined light emission amount set by an overall control unit 211 in the camera body part 2. In image capturing with a flash, reflection light of flash light from the subject is received by the light control sensor 305 simultaneously with start of exposure. When the received light amount reaches a predetermined light emission amount, a light emission stop signal is outputted from the light control circuit 304 to a flash control circuit 214 in the camera body part 2 via the overall control unit 211. In response to the light emission stop signal, the flash control circuit 214 forcedly stops light emission of the built-in flash 5, thereby controlling the light emission amount of the built-in flash 5 to the predetermined light emission amount.

The image capturing part 3 has therein a zoom motor 307 for changing a zoom ratio of the zoom lens 301 and moving the lens between a housing position and an image capturing position, and the AF motor 308 for achieving focus. The AF control will be described in detail later.

The internal configuration of the camera body part 2 will now be described.

The overall control unit 211 is constructed mainly by a CPU and controls an image capturing operation of the digital camera 1 by controlling driving of peripheral devices in the image capturing part 3 and the camera body part 2 connected via an address bus, a data bus and a control bus.

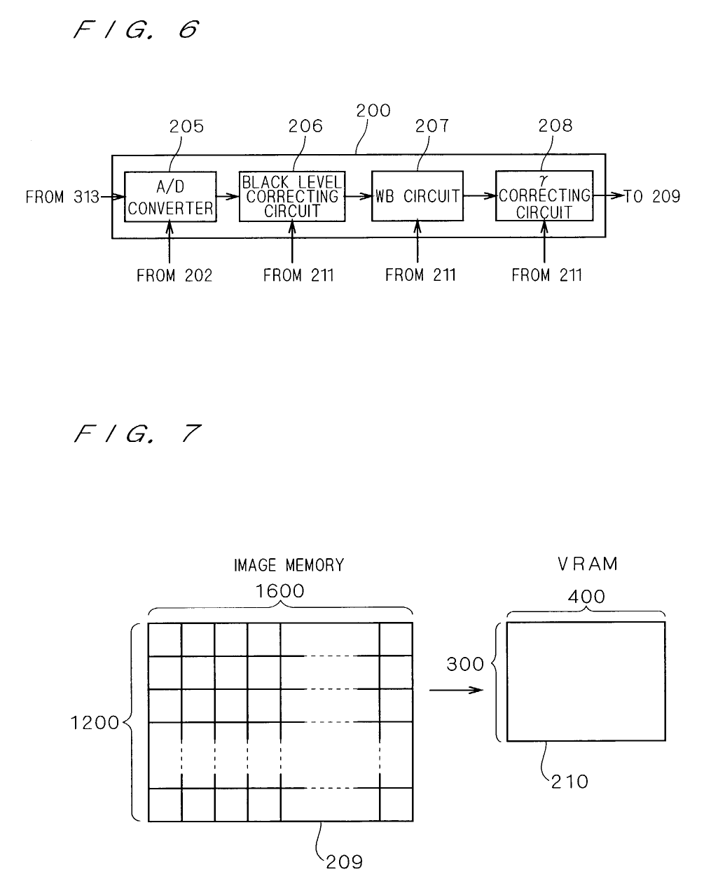

The flow of image data in FIG. 5 (and FIG. 6 which will be described later) is indicated by arrows connecting the peripheral devices for convenience. Actually, image data is transmitted to each peripheral device via the overall control unit 211. The overall control unit 211 has therein a work RAM 211a taking the form of a DRAM and a flash ROM 211b for storing a program.

The process of an image signal and the configuration related to image display in the camera body part 2 will now be described.

An analog image signal outputted from the signal processing circuit 313 of the image capturing part 3 is inputted to an image processing unit 200 in the camera body part 2 and subjected to various image processes in the image processing unit 200. FIG. 6 is a block diagram showing the configuration of the image processing unit 200. First, the analog image signal transmitted to the image processing unit 200 is converted to a digital signal of 10 bits per pixel in an A/D converter 205. The A/D converter 205 converts each pixel signal (analog signal) to a digital signal of 10 bits on the basis of a clock for A/D conversion inputted from the timing control circuit 202.

The timing control circuit 202 generates a reference clock and clocks for the timing generator 314 and the A/D converter 205 under control of the overall control unit 211.

A black level correcting circuit 206 corrects the black level of an A/D converted pixel signal (hereinafter, referred to as “pixel data”) to a reference black level. A WB circuit 207 performs level shifting of pixel data of each of color components of R, G and B, and executes automatic white balance adjustment (AWB) in consideration of γ correction in a post process. The white balance is adjusted by using a level shifting table (to be accurate, data of the table) inputted from the overall control unit 211 to the WB circuit 207. A color component shift coefficient (gradient of characteristic) of the level shifting table is set for each captured image by the overall control unit 211.

A γ correcting circuit 208 corrects the γ characteristic of pixel data. An output from the γ correcting circuit 208 is transmitted to an image memory 209 as shown in FIG. 5.

The image memory 209 is a memory for storing pixel data outputted from the image processing unit 200 and has a storage capacity of at least one frame of an image. Specifically, when the CCD 303 has 1600×1200 pixels arranged in a matrix, the image memory 209 has a storage capacity of pixel data of 1600×1200 pixels, and each pixel data is stored in a corresponding storage area (address).

A VRAM 210 is a buffer memory of image data displayed on the LCD 10 in a checking mode after image capturing (review and reproduction modes). The VRAM 210 has a storage capacity of image data corresponding to 400×300 pixels of the LCD 10, that is, a capacity of 400×300 pixels.

With such a configuration, in an image capturing standby mode in the image capturing mode, each of pixel data of an image captured every predetermined interval by the image capturing part 3 is processed by the image processing unit 200, stored in the image memory 209, transferred to the VRAM 210 via the overall control unit 211, and displayed on the LCD 10. In such a manner, live view display of displaying images of a subject before image capturing like moving images on the LCD 10 can be performed.

In the live view display, as shown in FIG. 7, when image data in the image memory 209 with 1600×1200 is reduced to ¼ in the vertical and horizontal directions and the resultant image data is transferred to the VRAM 210 with 400×300 pixels.

When the enlarging display button 224 is depressed here, image data with 400×300 pixels in the image memory 209 is extracted and transferred to the VRAM 210, thereby enlarging the image by four times in the vertical and horizontal directions. As described above, by depressing the enlarging display button 224, the user can easily switch an image between the image captured by the CCD 303 and its enlarged image on the LCD 10.

In the reproduction mode, the image read from the memory card 91 is subjected to a predetermined signal process by the overall control unit 211 and, after that, the resultant image is transferred to the VRAM 210 and reproduced and displayed on the LCD 10. At the time of displaying an image on the LCD 10, a back light 16 is turned on by the control of the overall control unit 211.

The other internal configuration of the camera body part 2 will now be described.

A card I/F 212 is an interface for transmitting/receiving a signal to/from the memory card 91 loaded in the card loading room 17. Concretely, via the card I/F 212, image data is written/read to/from the memory card 91.

The flash control circuit 214 is a circuit for controlling light emission of the built-in flash 5 as described above. The flash control circuit 214 controls light emission, a light emission amount, a light emission timing and the like of the built-in flash 5 on the basis of a control signal of the overall control unit 211, and controls the light emission amount of the built-in flash 5 on the basis of a flash stop signal inputted from a light control circuit 304.

A clock circuit 219 is used to manage date and time of image capturing and driven by not-shown another power source.

The camera body part 2 has also therein a zoom motor driving circuit 215 for driving the zoom motor 307 and an AF motor driving circuit 216 for driving the AF motor 308. The circuits function in accordance with an operation of an operating unit 250 constructed by the shutter button 8 and the above-described various switches and buttons.

The shutter button 8 is a two-stage switch capable of detecting the touched state (S1) and the depressed state (S2) as employed in a silver-film camera. When the shutter button 8 is touched in the image capturing standby mode, the AF motor driving circuit 216 drives the AF motor 308 to move the zoom lens 301 to a position where focus is achieved.

When the buttons 231 and 232 are depressed, signals from the buttons are transmitted to the overall control unit 211. In accordance with an instruction of the overall control unit 211, the zoom motor driving circuit 215 drives the zoom motor 307 to move the zoom lens, thereby performing optical zooming.

The components in the camera body part 2 have been described above. The overall control unit 211 performs various functions by software other than transmission/reception of data to/from the peripheral devices and timing control.

For example, the overall control unit 211 has a filtering function, a recording image generating function and a reproduction image generating function to perform a process of recording a captured image.

The filtering function is to correct high frequency components of an image to be recorded by a digital filter, thereby correcting the picture quality regarding an outline.

The recording image generating function is to read pixel data from the image memory 209 and generate a thumbnail image and a compressed image to be recorded on the memory card 91. Concretely, while scanning pixel data in the image memory 209 in a raster scan direction, pixel data is read every 8 pixels in each of the horizontal and vertical directions, and sequentially transferred to the memory card 91, thereby recording the pixel data onto the memory card 91 while generating a thumbnail image. At the time of recording the compressed image data to the memory card 91, all of the pixel data is read from the image memory 209, subjected to two-dimensional DCT, and a predetermined compressing process according to the JPEG system such as Huffman coding, and the resultant is recorded onto the memory card 91.

As a concrete operation, in the image capturing mode, when image capturing is instructed by the shutter button 8, a thumbnail image of an image stored in the image memory 209 after the image capturing instruction and an image compressed according to the JPEG system at a set compression ratio are generated and stored into the memory card 91 together with tag information regarding the captured image (information such as frame number, exposure value, shutter speed, compression ratio, date of image capturing, data of the on/off state of flash at the time of image capturing, scene information, and a result of determination of an image).

The reproduction image generating function is a function of generating a reproduction image by decompressing the compressed image recorded on the memory card. As a concrete operation, when the mode setting switch 14 is set in the reproduction mode, image data of the largest frame number in the memory card is read and decompressed, and the resultant data is transferred to the VRAM 210. Consequently, on the LCD 10, an image of the largest frame number, that is, an image captured latest is displayed.

Regarding AF

In the digital camera 1, the AF cursor CR corresponding to the AF area AR is displayed on the LCD 10, which will be described later.

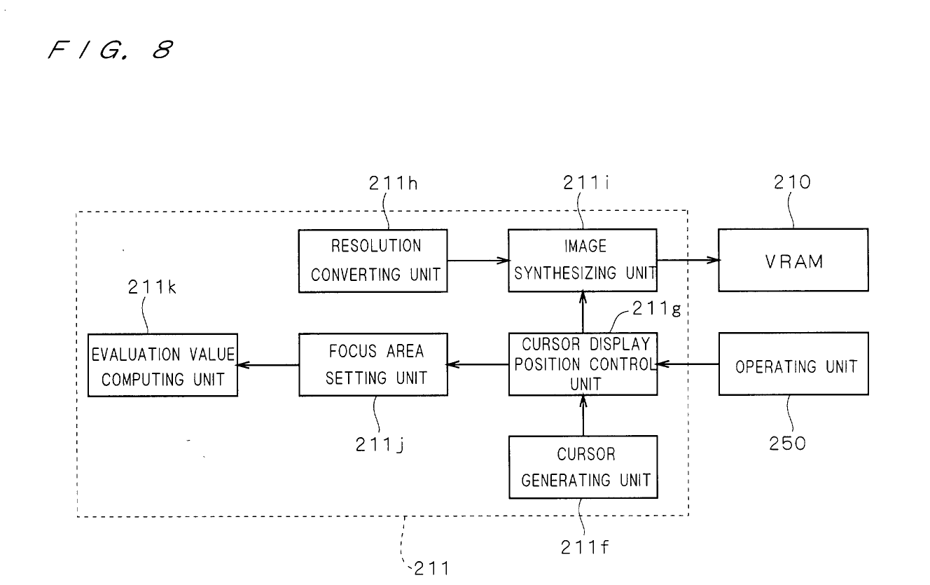

FIG. 8 is a partial block diagram of the digital camera 1.

The overall control unit 211 has a cursor generating unit 211f, a cursor display position control unit 211g, a resolution converting unit 211h, an image synthesizing unit 211i, a focus area setting unit 211j, and an evaluation value computing unit 211k.

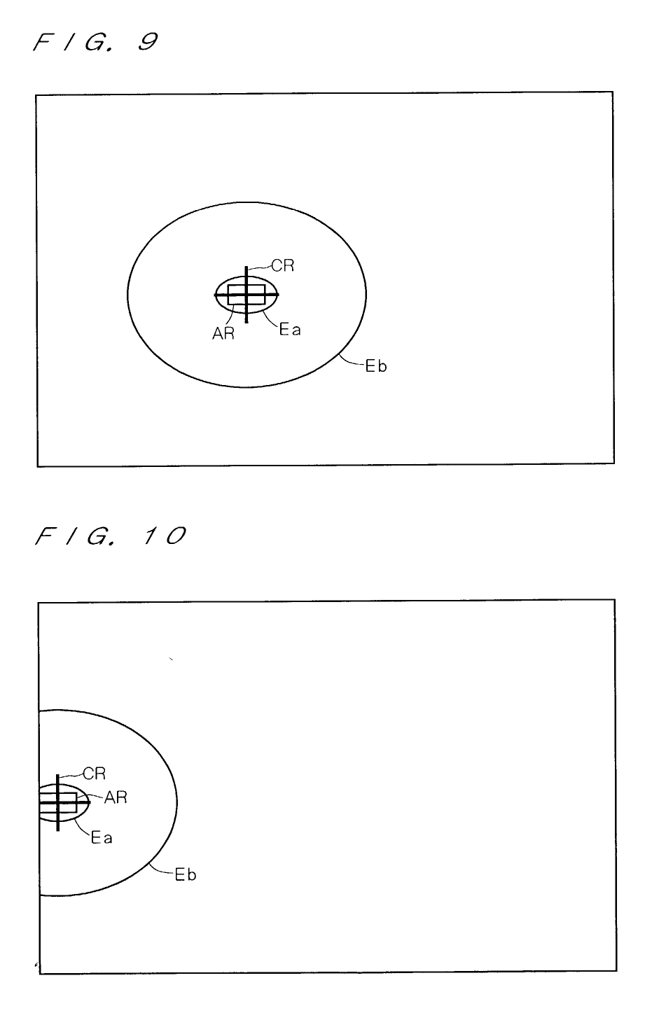

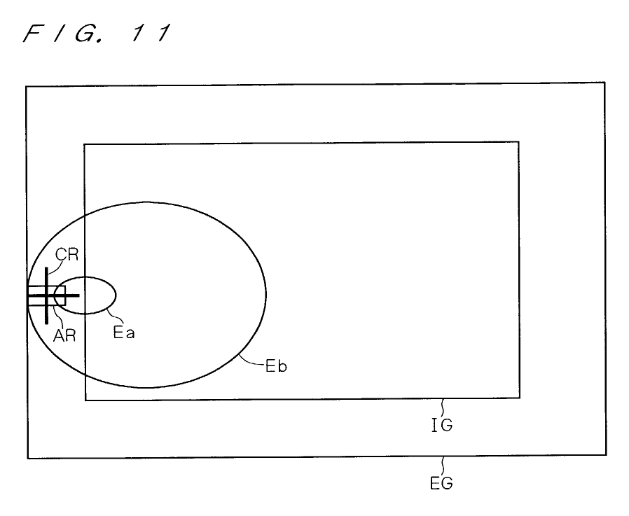

The cursor generating unit 21 If reads cursor data for generating the AF cursor CR shown in FIG. 9 and the like on the LCD 10 from the flash ROM 211b and transfers the cursor data to the cursor display position control unit 211g. The AF cursor CR shown in FIG. 9 and so on has a cross shape and a size of 16×16 pixels on the LCD 10. The AF cursor CR is to designate a specific point on a subject by the intersection point (center point) of the cross (since the number of pixels of the LCD 10 and that of the CCD 303 are different from each other, when one pixel is designated on the LCD 10, 4×4 pixels in the CCD 303 are designated in reality). By moving the AF cursor CR on the screen of the LCD 10 by a key operation of the user, the focus position in the subject can be designated. The AF cursor CR does not always have to have a cross shape but may have, for example, a rectangular frame shape like an AF area AR which will be described later.

The cursor display position control unit 211g changes the display position of the AF cursor CR on the LCD 10 on the basis of the operation entered to the operating unit 250 (four-way switch 230) by the operator.

As described above, the resolution converting unit 211h generates an image obtained by reducing the image data acquired by the CCD 303 to ¼, and transfers the reduced image to the image synthesizing unit 211i in a normal display mode. On the other hand, in an enlarging display mode, the resolution converting unit 211h transfers a part of the image data acquired by the CCD 303 as it is to the image synthesizing unit 211i.

The image synthesizing unit 211i synthesizes an image inputted from the resolution converting unit 211h and the image of the AF cursor CR inputted from the cursor display position control unit 211g and transmits the composite image to the VRAM 210. By the synthesizing operation, the size of the AF cursor CR on the LCD 10 is unchanged irrespective of a reduction ratio of the resolution converting unit 211h. This similarly applies also to the case of electronic zooming.

The focus area setting unit 211j sets the AF area AR used for focusing, which corresponds to the position of the AF cursor CR on the screen of the LCD 10. The AF area AR has a size of 200 pixels in the lateral direction and 80 pixel in the vertical direction in the CCD 303 with 1600 pixels horizontally by 1200 pixels vertically. The AF process is performed with the number of pixels of 200×80. The number of pixels of 200 horizontally by 80 vertically corresponds to the size of 50 pixels horizontally by 20 pixels vertically on the screen (400×300) of the LCD 10.

The evaluation value computing unit 211k performs an evaluation value computing operation for performing AF of a contrast method (or hill climbing method) when the shutter button 8 is touched by the user (S1). In this case, with respect to captured image data corresponding to the AF area AR which will be described later, an evaluation value as a sum of absolute values of the difference between neighboring pixels is computed. The lens is driven and the lens position in which the evaluation value is the largest is determined as a focus position. Consequently, the zoom lens 301 is driven to the AF area AR corresponding to the focus position to achieve focus, so that focus can be achieved on a main subject or the like.

Regarding AE

AE based on center-weighted metering in the position of the AF cursor CR in the LCD 10 screen is performed. In other words, the AF cursor CR also functions as the AE cursor corresponding to the metering point. In this example, the metering area regarding AE is set in correspondence with the AF cursor CR. The AE cursor indicative of the center of the metering area as a metering point may be displayed separately from the AF cursor CR. This will be similarly applied to the second and third embodiments which will be described later.

In the metering, as shown in FIG. 9, ellipses Ea and Eb functioning as metering areas are set around the AF cursor CR as a center and, for example, by designating a weighting factor of 8 to the inside of the ellipse Ea and designating a weighting factor of 2 to the area between the ellipses Ea and Eb, metering computation on image data obtained by the CCD 303 is executed. It enables proper metering on the main subject to be performed.

For example, in the case where the main subject is positioned at the end of the screen and the AF cursor CR is positioned at the end of the screen as shown in FIG. 10, if the ellipses Ea and Eb used for metering are set around the AF cursor CR as a center, a part of each of the ellipses Ea and Eb lies off the screen, and balance of the metering deteriorates.

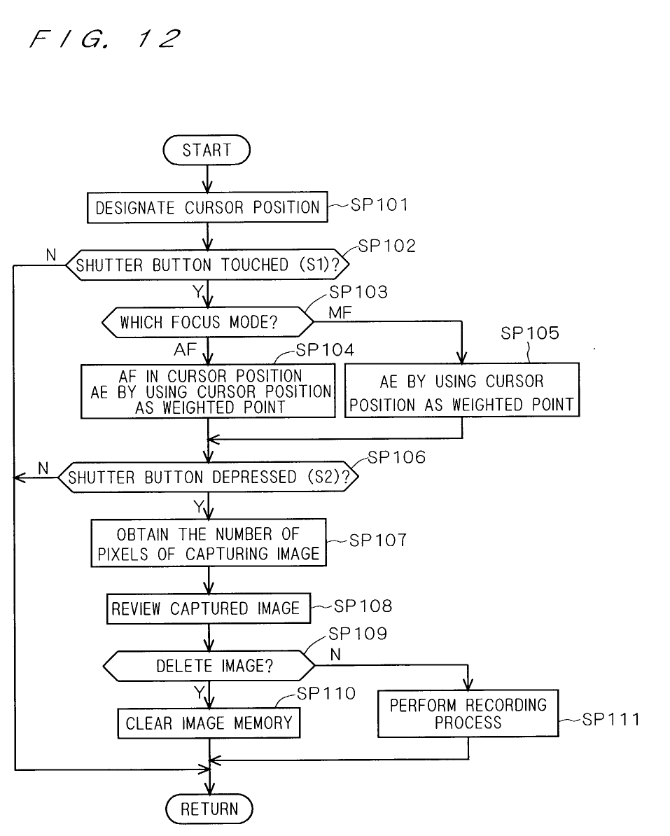

Consequently, as shown in FIG. 11, a rectangular-shaped regulation area IG is set in the center of the screen. When the center of the AF cursor CR lies off the regulation area IG, the center of the ellipse Ea is moved to the end of the regulation area IG and the ellipse Eb is moved so as to be in contact with the periphery of a screen EG. By moving the center of the metering area to the center of the screen more than the AF cursor CR as described above, balanced metering can be performed. When a result of the metering is used, a proper exposure control can be performed.

Operation of Digital Camera 1 According to the First Embodiment

The operation of the digital camera 1 will be described later. The operation is automatically executed by the overall control unit 211.

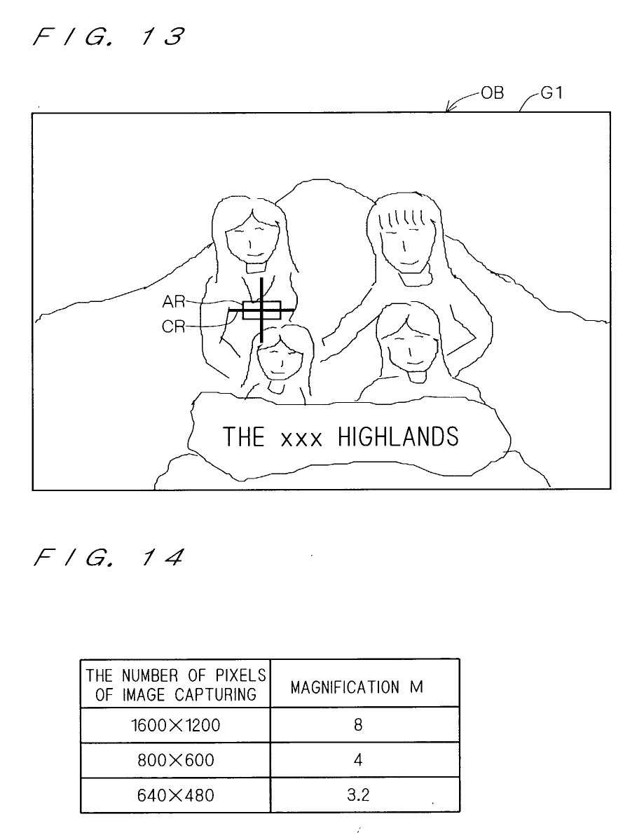

FIG. 12 is a flowchart for concretely describing the operation of the digital camera according to the first embodiment of the present invention. By using the live view state as a start, first, in step SP101, when the user operates the four-way switch 230, the AF cursor CR is moved in the screen of the LCD 10. By the operation, the focus position in a subject OB is designated. FIG. 13 shows a frame G1 displayed on the LCD 10 in this state.

In step SP102, whether the shutter button 8 is touched (S1) by the user or not is determined. If “NO” in step SP102, the program return to “start”. If “YES” in step SP102, the program advances to step SP103 and the focus mode (an AF mode or an MF mode) is determined.

When it is determined in step SP103 that the AF mode is set, the program advances to step SP104 where AF operation is performed on the basis of the position of the AF cursor CR by the driving of the zoom lens 301 and AE according to the center-weighted metering is performed by using the position of the AF cursor CR as a center. On the other hand, when it is determined in step SP103 that the MF mode is set, the program advances to step SP105 where a focusing operation is performed by driving the AF motor 308 by a manual operation of the user. By using the position of the AF cursor CR as a center, AE according to the center-weighted metering is performed.

Subsequent to step SP104 or SP105, in step SP106, whether the shutter button 8 is fully depressed (S2) by the user or not is determined. If “NO” in step SP106, the program returns to “start”. If “YES”, the program advances to step SP107 where an image of the subject OB is captured by the CCD 303 and stored into the image memory 209. Information regarding the number of pixels of the image capturing which is presently set is also obtained.

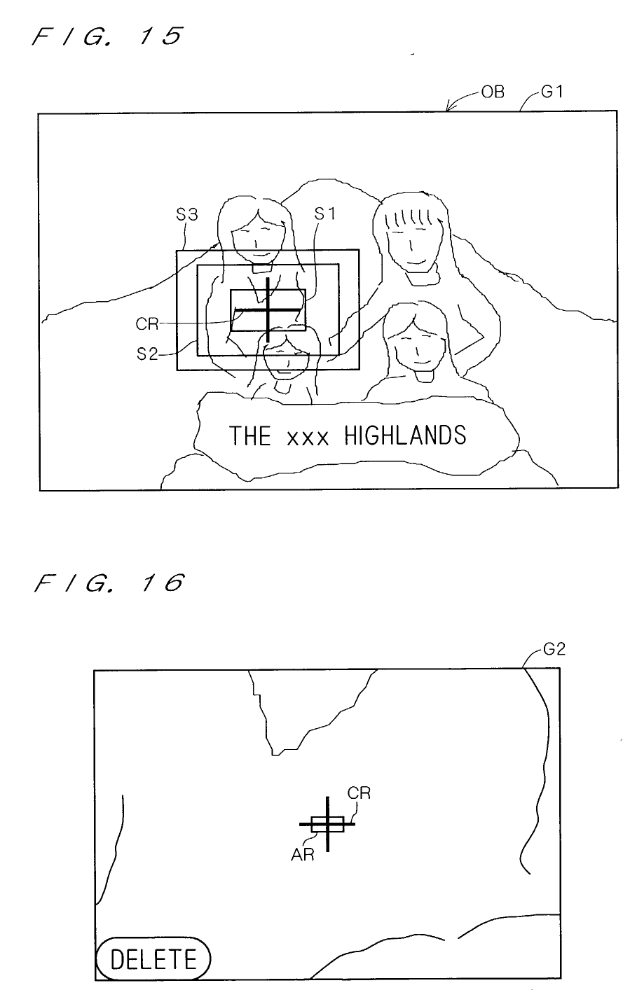

In step SP108, the captured image is reviewed. In the review of the digital camera 1 according to the first embodiment of the present invention, the whole image captured is not displayed on the LCD 10 but a part of the captured image is enlarged and the enlarged image is displayed on the full screen of the LCD 10. At this time, according to the image capture pixel mode, the magnification M of the image is automatically changed to a magnification which is preset in the flash ROM 211b. Concretely, as shown in FIG. 14, in the image capturing pixel mode (referred to as “very high resolution mode”) of 1600×1200 pixels, the magnification M is 8. In the image capturing pixel mode of 800×600 (referred to as “high resolution mode”), the magnification M is 4. In the image capturing pixel mode of 640×480 (referred to as “standard mode”), the magnification M is 3.2. The correspondence relations are prestored in a table.

The reason why the magnification M is set to the above values will be described. As described above, the number of pixels of the CCD 303 is 1600 pixels in the horizontal direction and 1200 pixels in the vertical direction, and the number of pixels of the LCD 10 is 400 pixels in the horizontal direction and 300 pixels in the vertical direction. For example, in the very high resolution mode, the magnification M is consequently 4 in the case where one pixel in the CCD 303 is made correspond to one pixel of the LCD 10. However, to make the focus state easily checked, the image is further doubled so that the magnification M becomes 8. The high resolution mode and the standard mode are similarly determined.

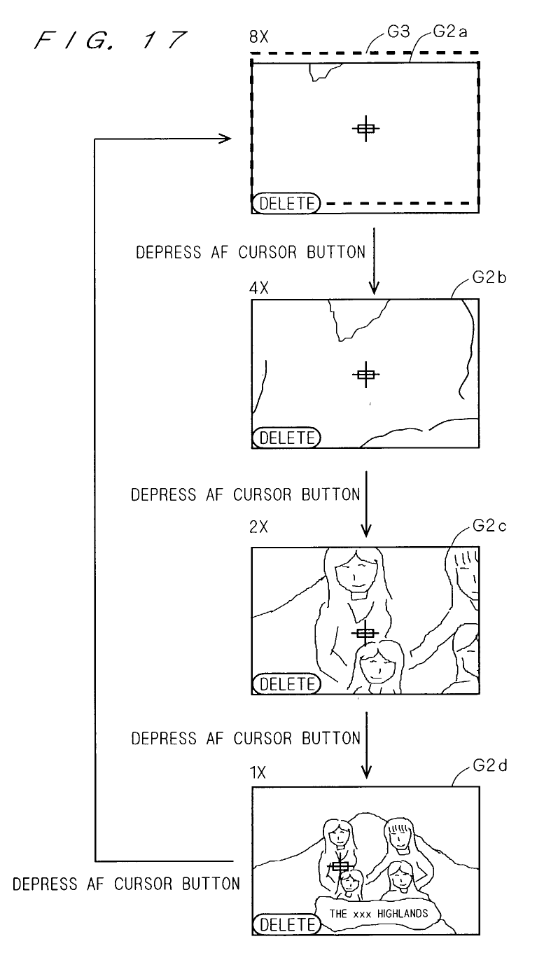

As a result, at the time of reviewing, as shown in FIG. 15, in the very high resolution mode, an area S1 to be enlarged is enlarged. In the high resolution mode, an area S2 to be enlarged is enlarged. In the standard mode, an area S3 to be enlarged is enlarged. The enlarged image is displayed in the full screen of the LCD 10. Each of the areas S1 to S3 to be enlarged is set as a rectangular area (generally, an area having a predetermined shape) including the AF cursor CR and using the AF cursor CR as a center. By designating the center of enlargement of the area to be enlarged by using the cross-shaped cursor, as compared with the case where the center is designated by using a frame-shaped area (Japanese Unexamined Patent Publication No. 11-196301), the flexibility and precision of position designation by the user are higher. A countermeasure against the case where the AF cursor CR is moved close to an end of the screen will be described later in a third embodiment.

FIG. 16 shows the enlarged image G2 displayed on the LCD 10 at the time of reviewing an image captured in the very high resolution mode in correspondence with the area S1 to be enlarged in FIG. 15.

Referring again to the flowchart, in step SP109 subsequent to step SP108, whether the image which has been captured lately and is being reviewed at present is deleted or not is selected by a key operation of the user. When the user wishes to delete the image for reason such as out-of-focus, by depressing the switch 221 positioned directly below the “delete” mark in the review screen, deletion can be selected.

If “YES” in step SP109, that is, when deletion of the image is selected, the program advances to step SP110 where the data of the image stored in the image memory 209 is deleted and, after that, returns to “start”. On the other hand, when “NO” in step SP109, that is, when predetermined time has elapsed in the state shown in FIG. 16 where no operation is performed, the program advances to step SP111, and the image stored in the image memory 209 is recorded in the memory card 91. After that, the program returns to “start”.

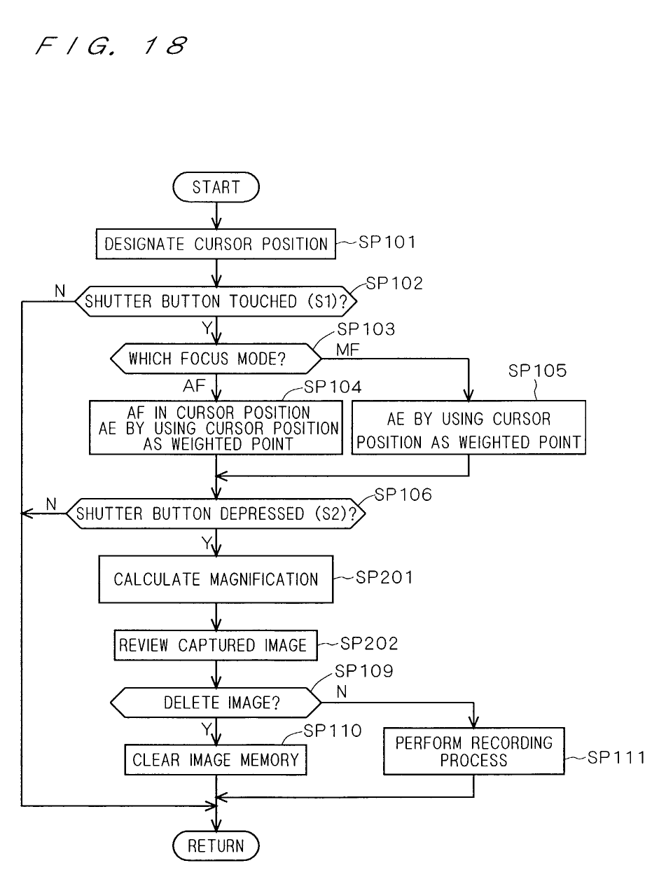

The digital camera 1 according to the first embodiment of the present invention also has the function capable of changing the magnification of a screen displayed on the LCD 10 at a few stages at the time of review by a key operation of the user. Referring to FIG. 17, it is assumed that an image G2a with the magnification M of 8 is automatically displayed on the LCD 10 at the time of reviewing by the above-described operation (that is, in the very high resolution mode). When the user depresses the AF cursor button 225 in this state, an image G2b with the magnification M of 4 is displayed on the LCD 10 by using data of the image stored in the image memory 209. When the user depresses the AF cursor button 225 in this state, an image G2c with the magnification M of 2 is displayed on the LCD 10 by using the data of the image stored in the image memory 209. When the user further depresses the AF cursor button 225, an image G2d with the magnification M of 1 is displayed on the LCD 10. When the user depresses the AF cursor button 225 in a state where the image G2d is displayed on the LCD 10, the image G2a is displayed again on the LCD 10.

When the user depresses the four-way switch 230 in a state where any of the images G2a to G2c with the magnification M which is not 1 is displayed on the LCD 10, the screen is scrolled in the direction of the depressed one of the buttons 231 to 234. When the user depresses the button 233 in a state where, for example, the image G2a is displayed, by using the data of the image stored in the image memory 209, an image G3 in a range indicated by broken line is displayed on the LCD 10.

In the digital camera according to the first embodiment of the present invention as described above, the magnification M of an area to be enlarged is automatically changed according to the number of pixels selected at the time of capturing an image. Thus, in the checking mode after capturing an image, the enlarged image G2 enlarged at a proper magnification M can be displayed on the LCD 10 in accordance with the depth of field for each number of pixels of image capturing. Therefore, when an image is captured in the image capturing pixel mode in which the number of pixels of the image is relatively small, a situation such that the image is excessively enlarged and displayed can be avoided. Improvements in operability at the time of checking a captured image can be consequently achieved.

Second Embodiment

Although a digital camera according to a second embodiment of the present invention has a structure similar to that of the digital camera 1 according to the first embodiment, a method of setting the magnification at the time of reviewing is different from that of the first embodiment.

Operation of Digital Camera According to Second Embodiment

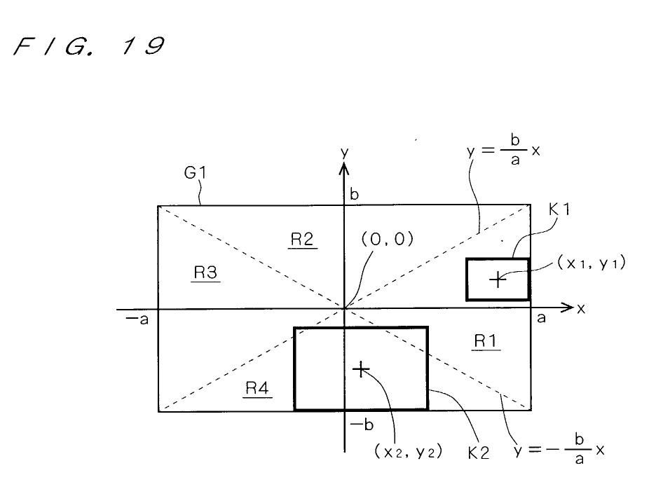

FIG. 18 is a flowchart for concretely describing the operation of the digital camera according to the second embodiment of the present invention. The operations in steps SP101 to SP106 are similar to those in the first embodiment. If “YES” in step SP106, the program advances to step SP201 where an image of the subject OB is captured by the CCD 303 and stored in the image memory 209. With the operation, the magnification is calculated.

FIG. 19 is a schematic diagram for describing a method of calculating the magnification in step SP201. In the digital camera according to the second embodiment of the present invention, while maintaining the relation that the position of the AF cursor CR coincides with the center position of the area to be enlarged, the magnification of the area to be enlarged is calculated in accordance with the position of the AF cursor CR in the screen of the LCD 10. The cursor is not always limited to the AF cursor CR. Any cursor may be used as long as it designates a specific position in the subject OB by an operation input of the user. For example, when movable AF and AE cursors are separately displayed, the magnification of the area to be enlarged may be calculated according to the position of the AE cursor. This will be similarly applied to a third embodiment which will be described later.

The method of calculating the magnification on the basis of the position of the AF cursor CR will be described later. As shown in FIG. 19, the x-axis and y-axis having coordinates (0, 0) in the center of the frame G1 are specified, and the position of the AF cursor CR in the frame G1 is expressed by using the x and y coordinates. A diagonal line y=(b/a) y connecting the lower left corner and the upper right corner of the frame G1 and a diagonal line y=−(b/a) y connecting the upper left corner and the lower right corner of the frame G1 are specified, and the frame G1 is divided into regions R1 to R4 by the diagonal lines as boundaries.

The region R1 is an area expressed by the following expression (1).

$$- \frac{b}{a} x \leq y \leq \frac{b}{a} x \qquad ( 1 )$$

When the AF cursor CR lies in the region R1, the magnification m is calculated by the following expression (2).

$$m = \frac{a}{a - x} \qquad ( 2 )$$

As shown in FIG. 19, when the coordinates of the AF cursor CR are expressed by (x₁, y₁), as an area to be enlarged, an area K1 to be enlarged having the center in coordinates (x₁, y₁) and whose right side coincides with the right side of the frame G1 is set.

The region R2 is a region satisfying a condition expressed by the following expression (3).

$$y > \frac{b}{a} x . and . y > - \frac{b}{a} x \qquad ( 3 )$$

When the AF cursor CR lies in the region R2, the magnification m is, calculated by the following equation (4).

$$m = \frac{b}{b - y} \qquad ( 4 )$$

The region R3 is a region expressed by the following expression (5).

$$\frac{b}{a} x \leq y \leq - \frac{b}{a} x \qquad ( 5 )$$

When the AF cursor CR lies in the region R3, the magnification m is calculated by the following expression (6).

$$m = \frac{a}{x + a} \qquad ( 6 )$$

The region R4 is a region satisfying a condition expressing the following expression (7).

$$y < \frac{b}{a} x . and . y < - \frac{b}{a} x \qquad ( 7 )$$

When the AF cursor CR lies in the region R4, the magnification m is calculated by the following expression (8).

$$m = \frac{b}{y + b} \qquad ( 8 )$$

As shown in FIG. 19, when the coordinates of the AF cursor CR are expressed by (x₂, y₂), as an area to be enlarged, the area K2 to be enlarged whose lower side coincides with the lower side of the frame G1 is set.

Referring again to the flowchart, in step SP202, the area to be enlarged is enlarged at the magnification calculated in step SP201, and the resultant is reviewed. Referring to FIG. 19, for example, when the coordinates of the AF cursor CR are expressed by (x₁, y₁), the image in the area K1 to be enlarged is enlarged and the enlarged image is displayed on the LCD 10. When the coordinates of the AF cursor CR are expressed by (x₂, y₂), the image in the area K2 to be enlarged is enlarged and the enlarged image is displayed in the full screen of the LCD 10.

After step SP202, the program shifts to step SP109. The operations in step SP109 and subsequent steps are similar to those in the first embodiment.

As described above, in the digital camera according to the second embodiment of the present invention, irrespective of the position of the AF cursor CR, an enlarged image without a partial missing part can be displayed on the LCD 10 in the checking mode. Consequently, it can be prevented that the user feels uncomfortable when the enlarged image is displayed with a partial missing part.

Since the relation that the center position of the area to be enlarged coincides with the position of the AF cursor CR is maintained in the enlarged image displayed on the LCD 10 in the checking mode, there is no change in the line of sight of the user before and after image capturing, so that improvements in operability can be achieved.

Third Embodiment

Although a digital camera according to a third embodiment of the present invention has a structure similar to that of the digital camera 1 according to the first embodiment, it is different from the first embodiment with respect to handling in the case where the AF cursor CR is moved near an end portion of the screen.

Operations of Digital Camera According to the Third Embodiment

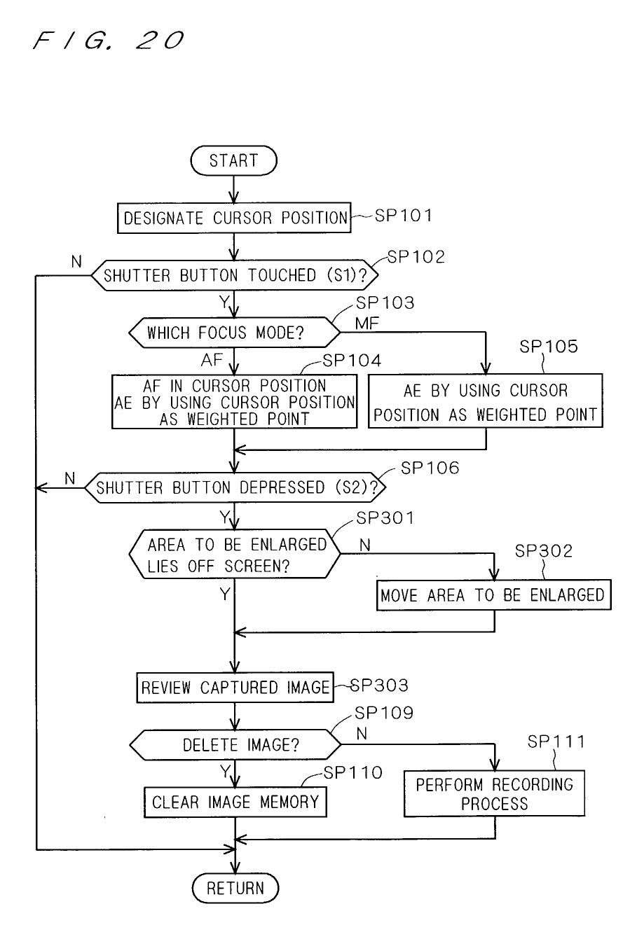

FIG. 20 is a flowchart for concretely describing the operation of the digital camera according to the third embodiment of the present invention. Operations from step SP101 to SP106 are similar to those of the first embodiment. If “YES” in step SP106, the program advances to step SP301, and an image of the subject OB is captured by the CCD 303, and stored into the image memory 209. With the operation, whether the area to be enlarged lies off the screen or not is determined.

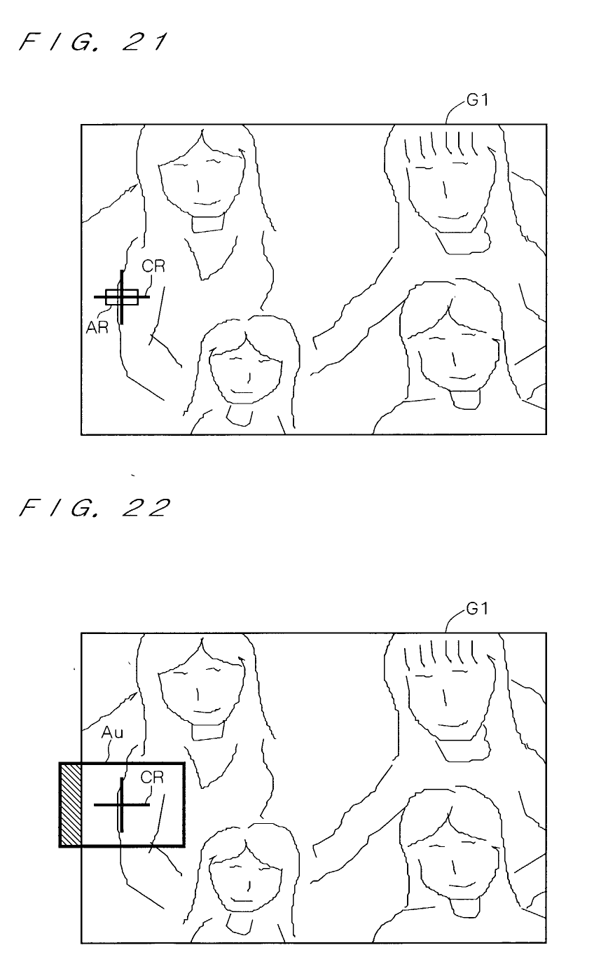

A case where the AF cursor CR is moved close to an end of the screen G1 by a key operation of the user as shown in FIG. 21 will be examined. In this case, when an area Au to be enlarged is set around the AF cursor CR as a center, as shown in FIG. 22, a part (hatched part in FIG. 22) of the area Au to be enlarged lies off the screen G1. The size of the area Au to be enlarged may be predetermined for each image capturing pixel mode as in the first embodiment or may be predetermined irrespective of the image capturing pixel mode.

If “NO” in step SP301, that is, when it is determined that the area Au to be enlarged lies off the screen Gi, in step SP302, the area Au to be enlarged is moved so as to be within the screen G1.

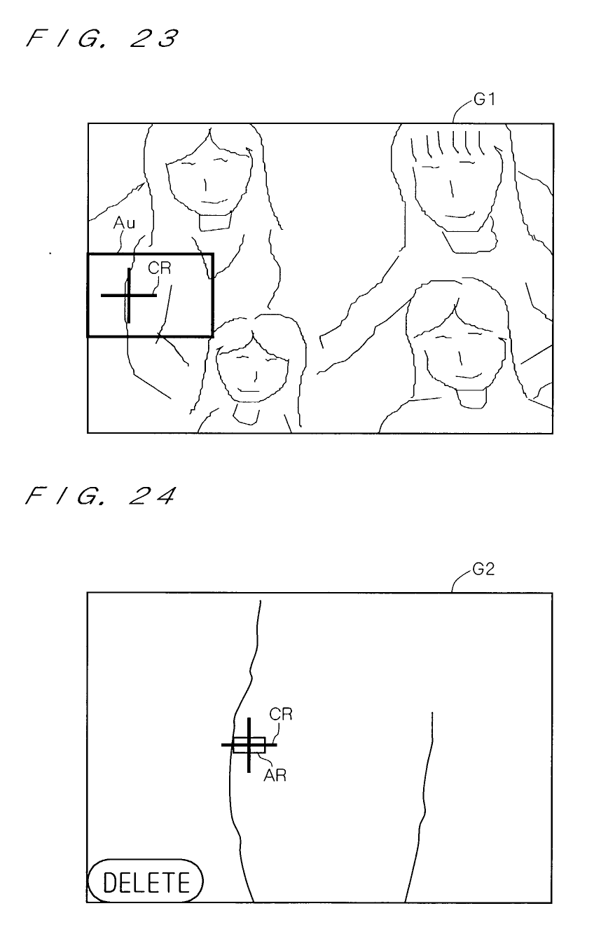

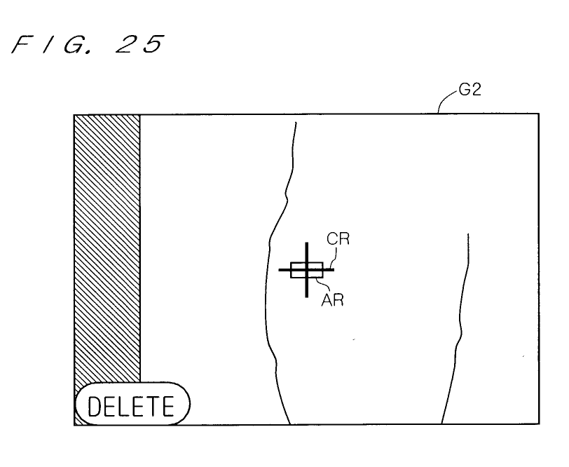

In the case where the area Au to be enlarged lies off the screen G1, when the area Au to be enlarged is enlarged as it is and the enlarged image is displayed in the full screen of the LCD 10 in the reviewing, an area other than the image obtained by the CCD 303 exists. Consequently, a situation such that the displayed enlarged image is partially missing occurs. To avoid such a situation, when a part of the area Au to be enlarged lies off from the screen G1 as shown in FIG. 22, as shown in FIG. 23, the area Au to be enlarged is moved in parallel in the horizontal direction of the screen GI so as to be within the screen G1. When an upper or lower part of the area Au to be enlarged lies off the screen G1, the area Au to be enlarged is moved in parallel in the vertical direction of the screen G1. As shown in FIG. 23, the center position of the area Au to be enlarged does not coincide with the position of the AF cursor CR, and the left side of the area Au to be enlarged coincides with the left side of the screen G1.

In step SP303 subsequent to step SP302, the image is reviewed. FIG. 24 shows the enlarged image G2 displayed on the LCD 10 at the time of reviewing in correspondence with the area Au to be enlarged in FIG. 23. If “YES” in step SP301, that is, when it is determined that the area Au to be enlarged is not off the screen G1, the program advances to step SP303 without moving to step SP302.

After step SP303, the program shifts to step SP109. The operations in step SP109 and subsequent steps are similar to those in the first embodiment.

In the digital camera according to the third embodiment of the present invention as described above, irrespective of the position of the AF cursor CR, the enlarged image G2 without a missing part can be displayed on the LCD 10 in the checking mode. Consequently, it can be prevented that the user feels strange to see the displayed enlarged image G2 with a partially missing part.

Since the magnification of the area Au to be enlarged is constant irrespective of the position of the AF cursor CR, the enlarged image G2 which is enlarged always at a predetermined magnification can be displayed on the LCD 10, and improvements in the operability can be achieved.

Modification of the Third Embodiment

In the third embodiment, when a part of the area Au to be enlarged lies off the screen G1, the area Au to be enlarged is moved so as to be within the screen G1. Alternately, it is also possible to enlarge the area Au to be enlarged which is partially off the screen G1, review the enlarged image, and paint a specific color such as blue in a missing part in the review screen. It makes it possible to clearly show the user that there is an area which cannot be displayed in the reviewed screen.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor for capturing an image of a subject and generating image data;
a display for displaying an image based on the image data generated by said image sensor onto a screen;
a designating member for designating a specific position in said subject on said screen;
a selector for selecting the number of pixels of an image captured by said image sensor; and
a display controller for enlarging an image in a predetermined area including said specific position designated by said designating member and displaying the enlarged image on said display, wherein
said display controller changes magnification of the image in said predetermined area in accordance with the number of pixels of the captured image selected by said selector.

2. The image capturing apparatus according to claim 1, wherein
said designating member designates a focus position in the subject.

3. The image capturing apparatus according to claim 1, further comprising:
an operating member for scrolling the image enlarged and displayed by said display controller.

4. The image capturing apparatus according to claim 1, further comprising:
an operating member for changing the magnification of an image enlarged and displayed by said display controller.

5. The image capturing apparatus according to claim 1, wherein
said display controller enlarges an image in said predetermined area including said specific position designated by said designating member and displays the enlarged image on said display at the time of reproducing the captured image.

6. An image capturing apparatus comprising:
an image sensor for capturing an image of a subject and generating image data;
a display for displaying an image based on the image data generated by said image sensor onto a screen;
a designating member for designating a specific position in said subject on said screen; and
a display controller for enlarging an image in a predetermined area including said specific position designated by said designating member and displaying the enlarged image on said display at the time of reproducing the captured image, wherein
said display controller displays the enlarged image so that a part other than the image is not displayed on said display.

7. The image capturing apparatus according to claim 6, wherein
said designating member designates a focus position in the subject.

8. The image capturing apparatus according to claim 6, wherein
said display controller changes the magnification of the image in said predetermined area in accordance with the specific position designated by said designating member.

9. The image capturing apparatus according to claim 8, wherein
said display controller changes the magnification of the image in said predetermined area in a state where a center position of said predetermined area and the specific position designated by said designating member coincide with each other.

10. The image capturing apparatus according to claim 6, wherein
when a position in the vicinity of an end of a screen is designated as said specific position by said designating member and a part of said predetermined area lies off said screen, said display controller moves said predetermined area so that said predetermined area lies within said screen.

11. An image capturing apparatus comprising:
an image sensor for capturing an image of a subject and generating image data;
a display for displaying an image based on the image data generated by said image sensor onto a screen;
a designating member for designating a specific position in said subject on said screen; and
a display controller for enlarging an image in a predetermined area including said specific position designated by said designating member and displaying the enlarged image on said display at the time of reproducing the captured image, wherein
when a position in the vicinity of an end of the screen is designated as a specific position by said designating member and a part of said predetermined area lies off said screen, said display controller produces a predetermined display other than an image in a portion corresponding to the part of said predetermined area.

12. The image capturing apparatus according to claim 11, wherein
the size and magnification of said predetermined area are constant.
